(19) United States
(12) Patent Application Publication
(10) Pub. No.: US 2003/0111065 A1
(43) Pub. Date: Jun. 19, 2003

(54) Variable capacity modular venturi system for exhaust gas recirculation in a diesel engine

(76) Inventor: David E. Blum, Bergen, NY (US)

Correspondence Address: Delphi Technologies, Inc., Mail Code 480414420, P.O. Box 5052, Troy, MI, 48007, US

(21) Appl. No.: 10/024,168

(22) Filed: Dec. 18, 2001

(51) Int. Cl. F02M 25/07

(52) U.S. Cl. 123/568.17

(57) ABSTRACT

A variable capacity modular venturi system for exhaust gas recirculation in a diesel engine having elements readily formed by die casting or injection molding. A throttle body controls the amount of fresh air being admitted directly to the engine intake manifold and variably diverts a portion of the air into exhaust gas mixing elements of the device. A mixing body connected to the throttle body receives the diverted air from the throttle body through an injection cone, receives exhaust gas diverted from the exhaust gas stream, and uses the diverted air stream to aspirate exhaust gas into a mixing chamber via a venturi element disposed concentrically within the mixing body. The mixed gases are combined with the stream of fresh air passing into the engine through a mounting base attachable to the intake manifold of the engine. The venturi element may be optimized to optimize the volume and mixture ratios of exhaust gas to fresh air to optimally meet the needs of any specific diesel engine application without alteration of other elements of the apparatus.

### TECHNICAL FIELD

The present invention relates to diesel engines; more particularly, to apparatus for controlling the recirculation of a portion of the diesel exhaust stream into the air intake; and most particularly, to a variable capacity modular venturi system for recirculation of exhaust gas that is inexpensive to manufacture and has interchangeable components for varying the flow of fresh air and exhaust gas through the system as may be required for different size engines.

### BACKGROUND OF THE INVENTION

Diesel engines are known to produce an exhaust stream that typically is relatively rich in unburned hydrocarbons and carbon particulates. These exhaust byproducts are significant components of atmospheric pollution, and reducing the percentage of such components in diesel exhaust is a desirable objective in the engine art.

It is known to controllably divert a portion of the exhaust stream of a diesel engine into the engine's air intake to recycle and reburn that portion of the exhaust, thereby lowering, at steady state, the pollutant concentration in the portion of the exhaust stream being discharged to the atmosphere. Such diversion is accomplished typically by installing an appropriately configured apparatus between the exhaust manifold and the intake manifold. In gasoline-powered engines, wherein a pressure differential between the exhaust stream and the intake stream drives the recirculation, a relatively simple exhaust gas recirculation (EGR) valve is typically employed. However, in a diesel engine, the pressure differential typically is very small; therefore, an EGR function for a diesel engine generally employs a venturi arrangement to aspirate exhaust gas into the fresh air stream entering the intake manifold. The shape of the fresh air and exhaust gas flow passages and the elements of the mixing body can be relatively complex, and can be difficult and expensive to fabricate. Such devices typically are formed by sand casting of aluminum, a relatively expensive process in which the inner sand mold is destroyed, thus requiring that a new mold be provided for each valve to be cast. Typically, sand-cast components have relatively thick walls, high dimensional variation, rough surfaces, and are subject to undesirable casting porosity. Components of such a device may require extensive machining to achieve a desired level of surface finish and critical dimensions.

Further, known devices have fixed throats and thus are each sized for a given engine requirement; the venturi elements are integrally cast with the mixing body and thus cannot be readily changed to adapt a given design of valve to a different engine requirement. Existing devices are configured to air flow specifications that can accommodate the air flow requirements of several engines to an acceptance level in each case, but not to an optimum performance level. Achieving optimum performance with the prior art configuration for different displacement engines requires separate and molds for each size engine, for which the tooling investments can be prohibitively expensive.

What is needed is an improved venturi mixing system for a diesel engine wherein the device is assemblable from a plurality of elements, including a venturi element, each carefully configured to be formed by die casting or injection molding, and wherein the configuration of only the venturi element need be altered to optimize the device for each engine in a range of diesel engine displacements.

It is a principal object of the present invention to provide an improved venturi mixing system for a diesel engine that may be formed by die casting or injection molding of aluminum or a composite polymer.

It is a further object of the invention to provide such a system wherein the size and shape of the venturi element may be varied as desired to adapt the overall system to engines having a range of displacements.

It is a still further object of the invention to provide such a system wherein the manufacturing costs are substantially reduced as compared to the prior art system.

### SUMMARY OF THE INVENTION

Briefly described, a variable capacity modular venturi system for exhaust gas recirculation in a diesel engine in accordance with the invention includes a plurality of assemblable elements, each performing a specific function or functions in the device, which elements may be readily formed by die casting or injection molding. A throttle body controls the amount of fresh air being admitted directly to the engine intake manifold and variably diverts a portion of the air into the exhaust gas mixing elements of the device. The portion of intake air mixed with exhaust gas preferably is determined and regulated by an engine control module (ECM) operationally attached to the throttle body. A mixing body connected to the throttle body receives the diverted air from the throttle body through an injection cone, receives exhaust gas diverted from the exhaust gas stream, and provides both to a mixing chamber via a venturi element disposed concentrically within the mixing body. The mixed gases are combined with the stream of fresh air passing into the engine through a mounting base attachable to the intake manifold of the engine. The size and shape of the fixed throat of the venturi element used in any individual device may be optimized to optimize the range of amounts of exhaust gas aspirated and the resulting volume and mixture ratios, to optimally meet the needs of any specific diesel engine application.

### BRIEF DESCRIPTION OF THE DRAWINGS

These and other features and advantages of the invention will be more fully understood and appreciated from the following description of certain exemplary embodiments of the invention taken together with the accompanying drawings, in which:

FIG. 1 is an elevational cross-sectional view of a prior art venturi device for exhaust gas recirculation in a diesel engine;

FIG.2 is an elevational cross-sectional view of a variable capacity modular venturi system for exhaust gas recirculation in a diesel engine, in accordance with the invention;

FIG. 3 is an elevational cross-sectional view of a throttle body for the modular venturi system shown in FIG. 2;

FIG. 4 is an elevational cross-sectional view like that shown in FIG. 3, taken in a plane orthogonal to the plane of the view in FIG. 3;

FIG. 5 is an elevational cross-sectional view of a mixing body for the modular venturi system shown in FIG. 2;

FIG. 6 is an elevational cross-sectional view of a venturi element for the modular venturi system shown in FIG. 2;

FIG. 7 is an elevational cross-sectional view of a mounting base for the modular venturi system shown in FIG. 2; and

FIG. 7 is an exploded view showing the assembly sequence of the mounting base, venturi element, mixing body, and throttle body shown in FIGS. 7, 6, 5, and 3, respectively.

### DESCRIPTION OF THE PREFERRED EMBODIMENTS

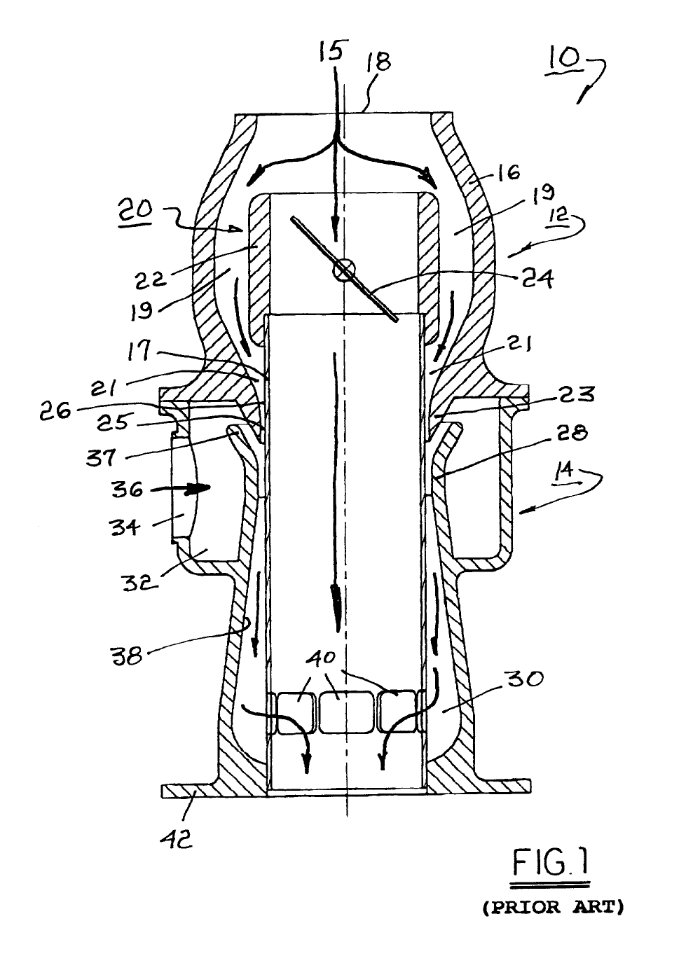

Referring to FIG. 1, a prior art venturi device 10 for exhaust gas recirculation in a diesel engine includes a throttle body element 12 and a venturi mixing body element 14. In throttle body element 12, a hollow housing 16 defines an entry port 18 for admission of fresh air 15 to an engine (not shown). Disposed within housing 16 and suspended therefrom by vanes (not shown) is a central throttle fixture 20 comprising a generally cylindrical throttle body 22 connected to a cylindrical fresh air pipe 17 connectable to a diesel engine intake manifold (not shown). A throttle plate 24 is disposed conventionally within throttle body 22 and operationally connected to an engine control module (not shown). Between housing 16 and throttle body 22 is an annular space 19 leading to a substantially conical air injection space 21 formed between pipe 17 and a conical portion 23 of housing 16. A portion of the fresh air entering the device through port 18 is excluded from throttle body 22 and pipe 17 by the action of throttle plate 24 and is diverted into mixing body 14 via space 19 and cone 21. The diverted air is thus injected into mixing body 14 as a substantially cylindrical air curtain 25 along the outer wall 26 of pipe 17.

Mixing body 14 includes a venturi element 28 surrounding pipe 17 and forming a mixing chamber 30 therebetween. Surrounding venturi element 28 is a plenum 32 having a port 34 for receiving exhaust gas 36. Venturi element 28 has a flared entrance lip 37 shaped to create a venturi effect with air curtain 25 in accordance with known aerodynamic principles, thereby aspirating a predetermined amount of exhaust gas from plenum 32 into chamber 30 where it mixes with the air in curtain 25. Preferably, the walls 38 of mixing chamber 30 are tapered away from pipe 17, causing a pressure drop in the gases and resulting in turbulent mixing of fresh air and exhaust gas. Pipe 17 is provided with a plurality of apertures 40 between the lower portion of mixing chamber 30 and the interior of pipe 17, whereby the mixed gases enter the fresh air stream to be carried into the engine for combustion. Venturi element 28 terminates in a base plate 42 for mounting device 10 conventionally onto the intake manifold of a diesel engine.

As noted above, the throttle body and the venturi mixing body are complex objects which, in the prior art, are formed of aluminum preferably by sand casting, the forms being unsuited to less-expensive forming methods such as injection molding or die casting in which the cast object is so shaped as to be readily separable from the mold at the conclusion of the process.

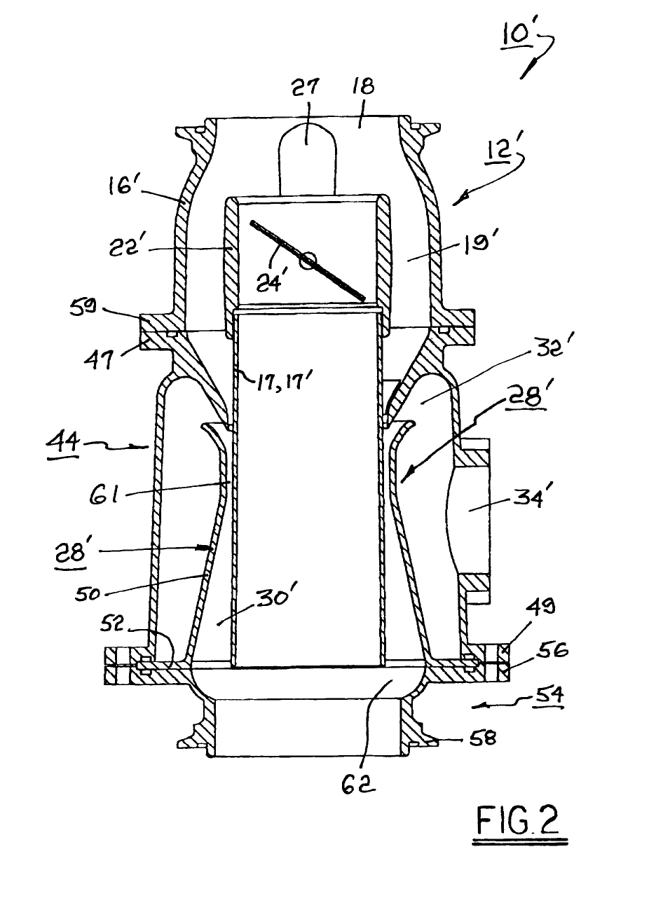

Referring to FIGS. 2 through 8, an improved venturi system 10′ for exhaust gas recirculation in a diesel engine is superior to prior art device 10 in being an assembly of moldable components and in having a replaceable venturi element 28′. The venturi element may be varied in size and shape to meet the recirculation requirements of various engines without having to change any of the other components of the device.

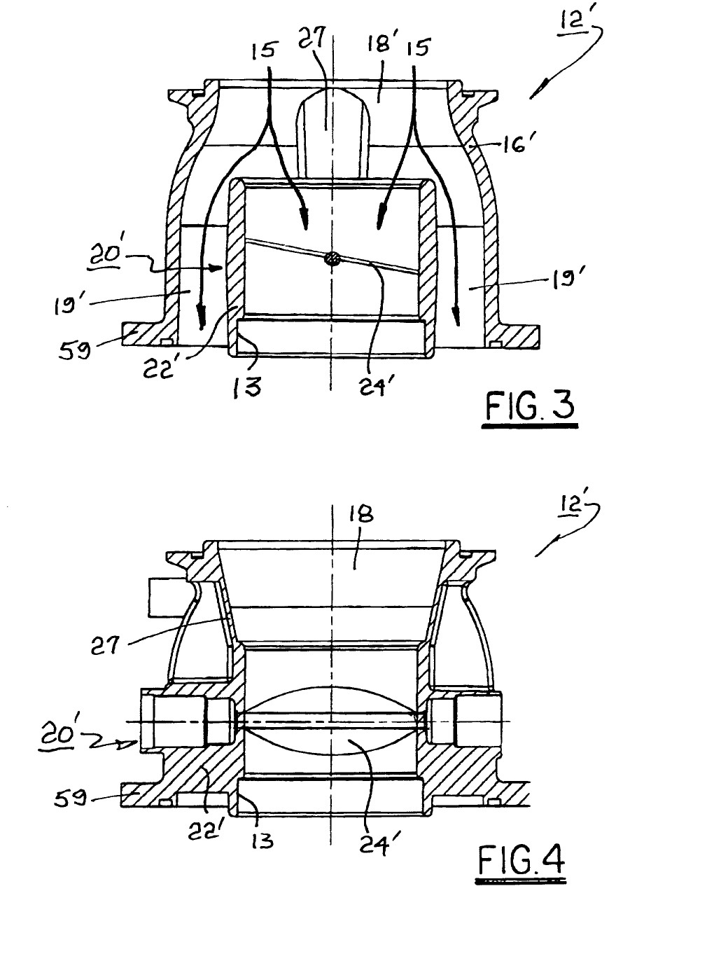

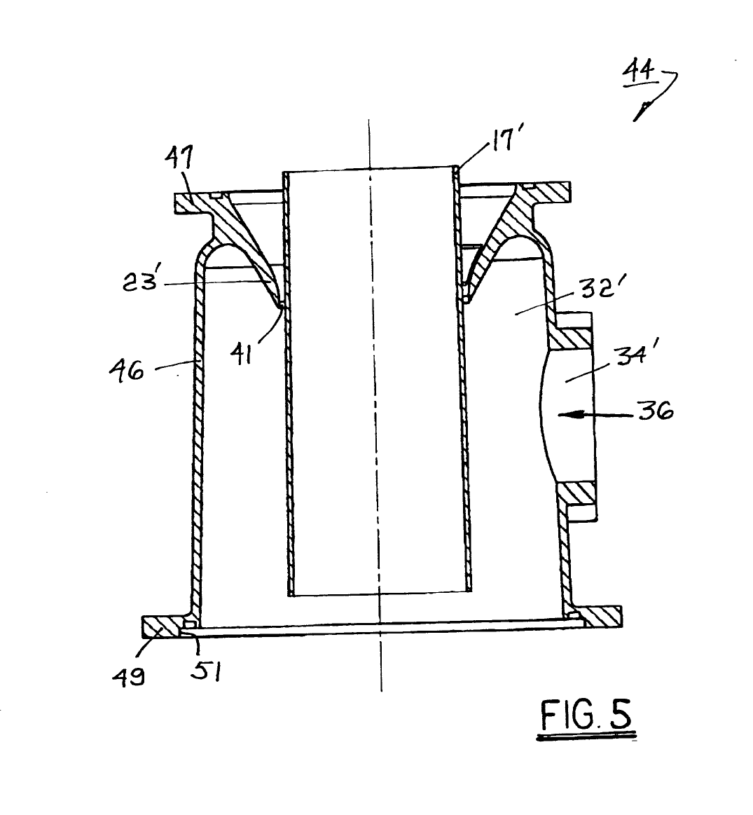

Referring to FIGS. 3 and 4, a throttle body element 12′ is similar in configuration and function to the upper portion of prior art throttle body element 12. A housing 16′ defines an entry port 18′ for admission of fresh air 15 to an engine (not shown). Disposed within housing 16′ and suspended therefrom by vanes 27 is a central throttle fixture 20′ comprising a generally cylindrical throttle body 22′ connectable via a shouldered seat 13 to a cylindrical fresh air pipe 17′ (FIG. 5). A throttle plate 24′ is disposed conventionally within throttle body 22′ and operationally connected to an engine control module (not shown). Between housing 16′ and throttle body 22′ is a space 19′. A portion of the fresh air 15 entering the system through port 18′ is excluded from throttle body 22′ and pipe 17′ by the action of throttle plate 24′ and is diverted into space 19′.

Referring to FIG. 5, a mixing body 44 includes a generally cylindrical outer wall 46, which may be flared slightly from top to bottom as desired to facilitate removal from a mold, and a cylindrical inner wall 17′ replacing pipe 17 in the prior art device. Of course, wall 17′ may be provided as a separate pipe 17 if so desired, for example, to simplify molding. Outer wall 46 defines a plenum 32′ having a port 34′ for receiving exhaust gas 36 and is recurved inwards at its upper end to form a conical air injector 23′ similar to prior art conical portion 23 of prior art housing 16. Pipe 17 or 17′ is preferably supported in the throat of injector 23′ on fins 41. Moving the conical air injector from the throttle body element to the mixing body allows both the improved mixing body 44 and the improved throttle body element 12′ to be injection molded rather than requiring sand casting. Outer wall 46 terminates in a first flange 47 for mating with flange 59 on throttle body 12′, and in a second flange 49 having an annular recess 51 formed in an axial face thereof.

Referring to FIGS. 2 and 6, an interchangeable venturi element 28′ includes a flared lower portion 48 and an upper lip portion 37′. Walls 50 flare outwards to form a mixing chamber 30′ between element 28′ and pipe 17′. Lip portion 37′ is shaped and sized to form an annular venturi orifice with pipe 17′ to aspirate exhaust gas from plenum 32′ into mixing chamber 30′. Walls 50 terminate at a lower end in a third flange 52 which, when received in recess 51, separates mixing chamber 30′ from plenum 32′.

Venturi element 28′ may be formed to have any shape and size as desired to cooperate with pipe 17′ to aspirate a predetermined amount of exhaust gas into chamber 30′. Preferably, flange 52 is identical on all such embodiments of element 28′ such that no other components need be modified in any way for the resulting various devices 10′ to be mounted on their respective engines. Venturi element 28′ is readily formed by injection molding or die casting.

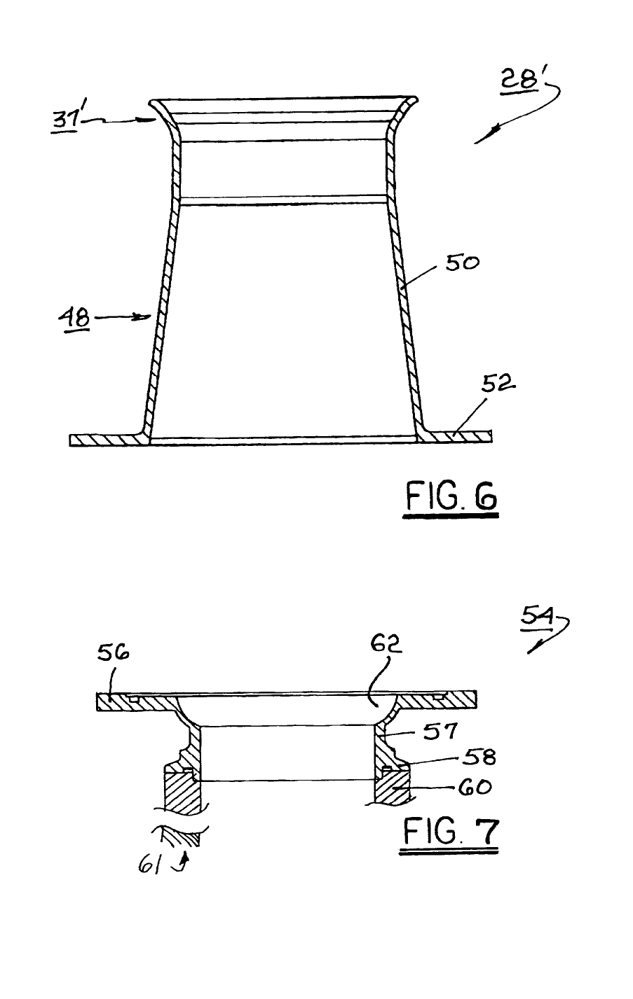

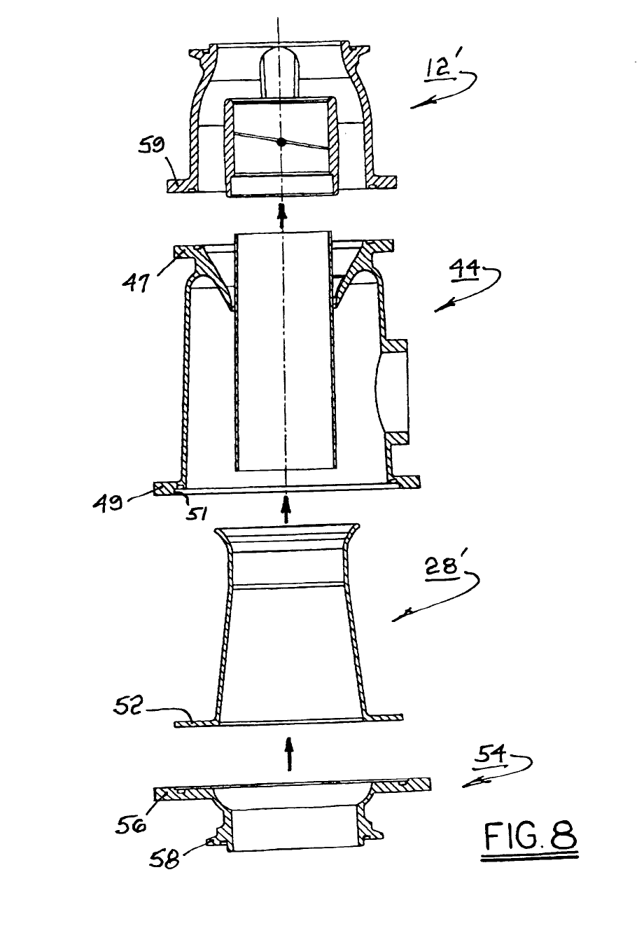

Referring to FIGS. 2 and 7, a mounting base 54 is formed having a flange 56 for mating with flange 49 on mixing body 44 to clamp venturi element 28′ therebetween. Base 54 preferably is further provided with a cylindrical portion 57 terminating in a flange 58 for mounting to an intake manifold 60 of diesel engine 61. Flange 56 surrounds a shallow recess 62 contiguous with cylindrical portion 57. Recess 62 provides an opening at the end of pipe 17′ between the mixing chamber 30′ and the interior of pipe 17′, analogous to apertures 40 in prior art pipe 17, for mixed gases to enter the fresh air stream into engine manifold 60. Mounting base 54 is readily formed by injection molding or die casting.

Referring to FIG. 8, to assemble a variable capacity modular venturi system 10′ in accordance with the invention, venturi element 28′ is entered into mixing body 44, surrounding pipe 17′, until flange 52 is seated in recess 51. Flange 56 is then secured to flange 49 as by bolting or welding in known fashion. Pipe 17′ is entered into seat 13 and flange 59 on throttle body 12′ is secured to flange 47 on mixing body 44 as by bolting or welding to complete the assembly of system 10′.

All the elements of system 12′ are readily formed by conventional die casting of metal, for example, aluminum or alloys thereof. In addition, the recent development of high-temperature polymers (for example, a glass-filled high-temperature nylon composite such as Zytel, available from E. I. DuPont de Nemours, Wilmington, Del., USA) permits some or all of the components to be injection molded of polymer conventionally at high temperture at a great reduction in cost over the aluminum sand-casting technique employed in manufacturing the prior art venturi device.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A variable capacity modular venturi system for aspirating exhaust gas into the fresh air stream entering the intake manifold of a diesel engine, the venturi system including separable components comprising:
a) a throttle body element for diverting a portion of the fresh air stream for mixing with exhaust gas;
b) a mixing body element attached to said throttle body element for receiving said diverted air portion, including a central pipe and having an injector portion for collimating said diverted air portion along an outer surface of said central pipe;
c) a venturi element disposed within said mixing body element and having a lip position for cooperating with said central pipe to form an annular venturi orifice for using said diverted air portion to aspirate exhaust gas into said diverted air portion, and having walls for cooperating with said mixing body element to form a mixing chamber therebetween for mixing said aspirated exhaust gas and said diverted air portion; and
d) a mounting base for securing said system to an intake manifold of a diesel engine, said base having a central recess receivable of an open end of said central pipe for entry of said mixed gases from said mixing chamber into the remainder of said fresh air stream.

2. A system in accordance with claim 1 wherein at least one of said separable elements is formed by a process selected from the group consisting of injection molding and die casting.

3. A system in accordance with claim 1 wherein at least one of said separable elements is formed of a material selected from the group consisting of aluminum, aluminum alloy, and a polymer.

4. A system in accordance with claim 1 wherein said venturi element is a module having a standard flange base for incorporation into said system and having said lip portion having size and shape dimensions which may be varied as desired to vary the volume of exhaust gas aspirated into said diverted air stream.

5. A diesel engine having a variable capacity modular venturi system for aspirating exhaust gas into the fresh air stream entering the intake manifold of the engine, the venturi system including separable components comprising:
a) a throttle body element for diverting a portion of the fresh air stream for mixing with exhaust gas;
b) a mixing body element attached to said throttle body element for receiving said diverted air portion, including a central pipe and having an injector portion for collimating said diverted air portion along an outer surface of said central pipe;
c) a venturi element disposed within said mixing body element and having a lip portion for cooperating with said central pipe to form an annular venturi orifice for aspirating exhaust gas into said diverted air portion, and having walls for cooperating with said mixing body to form a mixing chamber therebetween for mixing said aspirated exhaust gas and said diverted air portion; and
d) a mounting base for securing said system to an intake manifold of said diesel engine, said base having a central recess receivable of an open end of said central pipe for entry of said mixed gases from said mixing chamber into the remainder of said fresh air stream.
